(19) United States
(12) Patent Application Publication
(10) Pub. No.: US 2025/0190587 A1
(43) Pub. Date: Jun. 12, 2025

(54) ASSESSING AND IDENTIFYING RESPONSES TO SECURITY RISKS

(71) Applicant: Banyan Security, Inc., San Francisco, CA (US)

(72) Inventors: Rean Griffith, San Francisco, CA (US); Jayanth Gummaraju, Walnut Creek, CA (US)

(21) Appl. No.: 18/972,462

(22) Filed: Dec. 6, 2024

Related U.S. Application Data
(60) Provisional application No. 63/607,261, filed on Dec. 7, 2023.

(51) Int. Cl. G06F 21/57

(52) U.S. Cl. CPC G06F 21/577; G06F 2221/034

(57) ABSTRACT

A system and method are disclosed for making real-time access control decisions based on a trust score computed from multiple factors across users, devices, applications, and infrastructure. The trust score is used to provide differentiated and least privileged access to sensitive corporate data, thereby improving security posture and reducing the risk of data breaches. The system exposes the trust score to users, enabling them to check their and their device's security posture and improve it on their own. Additionally, the system provides an intuitive interface for security administrators to write policies based on the trust score, eliminating the need for role proliferation and simplifying access control management.

### CROSS-REFERENCE TO RELATED APPLICATIONS

The present patent application claims the priority benefit of U.S. provisional application 63/607,261 filed Dec. 7, 2023, the disclosure of which is incorporated herein by reference.

### BACKGROUND OF THE CLAIMED INVENTION

### 1. Field of the Invention

The present invention relates to security risks. More specifically, the present invention relates to assessing and identifying responses to security risks.

### 2. Description of the Related Art

Known enterprises have embraced a dynamic workforce and geographically distributed applications and services for speed of delivery and cost efficiency reasons. This shift has made it difficult to safeguard sensitive corporate data using traditional perimeter-based approaches to security using legacy tools such as virtual private networks (VPNs) and firewalls.

The workforce is no longer confined to employees working from office buildings. The number of “loosely-coupled users” of enterprises such as contractors, partners, vendors, suppliers, etc. may exceed even the total number of employees in the company. Furthermore, these users may access corporate data from their personal devices such as mobile phones and laptops, and/or from insecure locations such as coffee-shops and airplanes.

Therefore, there is a need for security tools to contribute to access decisions and improve the security profile for companies.

### SUMMARY OF THE CLAIMED INVENTION

To overcome these challenges, the example system quantifies the level of trust to attribute to accessing principals, whether they are users, devices, or client applications. The example system indicates how trustworthy the user and device are so that the platform can make access decisions to a company's sensitive resources. A trust score is computed in real-time using a plurality of user, device, and application factors collected from both sensors (e.g., access proxies, device applications) and/or a plurality of security tools already deployed in enterprise environments (e.g., intrusion detection and prevention systems (IDPs), endpoint detection and response systems (EDRs), mobile device management systems (MDMs), etc.).

The trust score also enables security administrators to write policies that provide differentiated, least privileged access to users based on the sensitivity of data they are accessing. The same role can have different levels of access based on the trust score, thereby avoiding role proliferation. Exposing the trust score to users also provides an intuitive way for the company workforce to check their and their device's security posture and improve it on their own. This enables employees to work in concert with the security teams, thereby reducing their burden and creating a safer corporate environment.

### BRIEF DESCRIPTION OF THE FIGURES

To easily identify the discussion of any particular element or act, the most significant digit or digits in a reference number refer to the figure number in which that element is first introduced.

FIG. 1 shows an example continuous zero trust platform.

FIG. 2 shows an example trust score computation logic.

FIG. 3 shows an example trust score, access score, and trust level calculation.

FIG. 4 illustrates a method in accordance with one embodiment.

FIG. 5 illustrates a block diagram of an exemplary computing system.

FIG. 6 illustrates an example neural network architecture.

### DETAILED DESCRIPTION

Applications and services exposing data, such as corporate data, are also no longer confined to datacenters running simple monolithic applications. At least some known applications are spread across one or more cloud platforms, various regions (e.g., US-East, Europe, Asia), and/or are built using different architectures (e.g., Kubernetes, microservices, three-tier). Additionally, consumers of application programming interfaces (APIs) exposed by applications include users, other applications, and/or microservices.

These trends have resulted in several challenges for securing access to corporate data. There are multiple data breaches every day, with, on average, more than 6M records lost or stolen per day. Lacking access controls is one of the most dominant causes for these breaches. These data show that existing perimeter-based approaches that rely on just authentication (e.g., multi-factor authentication) and network factors (e.g., Internet protocol (IP) addresses, network segments) are fundamentally insufficient to protect corporate data. To close this gap, a plurality of additional factors across users, devices, applications, and infrastructure may be taken into account to guard access to sensitive corporate data.

Security administrators have resigned themselves to specifying many roles and policies across different security tools to manage different levels of corporate access. This approach is not just time-consuming and complex, but also very error-prone and can open gaping security holes in enterprises' access posture. Furthermore, an average enterprises deploy more than 70 security tools today. These tools are disparate and span several aspects of security such as network security (VPNs, firewalls), application security (web application firewalls (WAFs), vulnerability management), user identity management (identity and access management (IAM)), endpoint security (endpoint detection and response (EDR)) and device management (master data management (MDM)). Although several such tools should affect access decisions for sensitive corporate resources, they are deployed in their own silos and it's very difficult to bring them together to make real-time access decisions.

Additionally, relatively small security teams (e.g., a couple for every thousand employees) are responsible for managing the entire corporate infrastructure. In addition to managing tens of security tools and supporting potentially insecure devices, they are also responsible for ensuring employees have secure access to their corporate data and are on the hook to immediately fix any issue that could cause a breach or affect employee productivity.

There is a need in the art for a system that enables real-time access control decisions, leveraging a trust score computed from multiple factors across users, devices, applications, and infrastructure, to provide differentiated and least privileged access to sensitive corporate data.

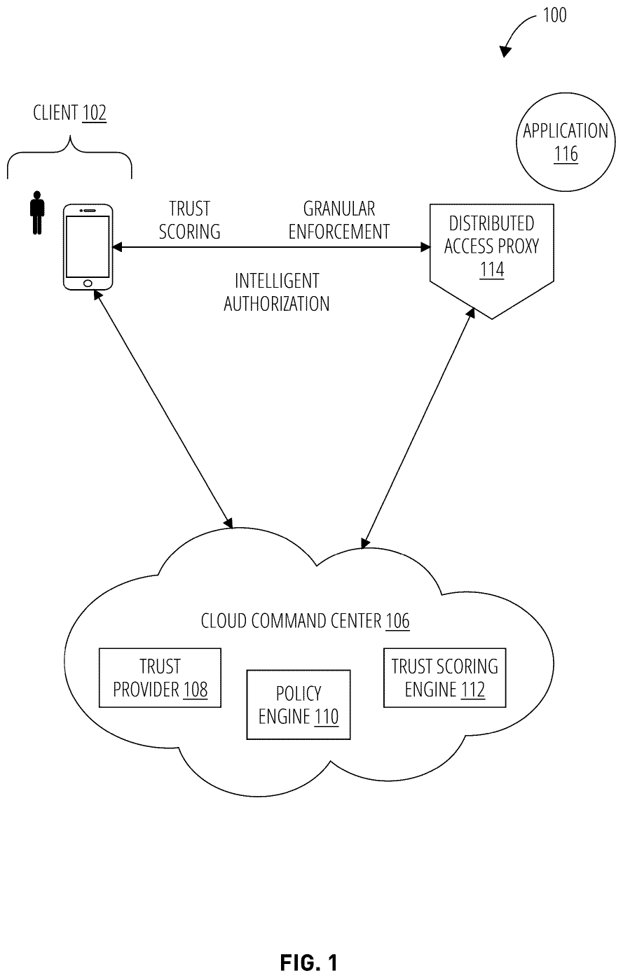

FIG. 1 shows an example continuous zero trust platform 100.

The continuous zero trust platform 100 embodies the architecture of developing a trust score and how the trust score is used to control access to sensitive corporate data. The motivation behind creating the trust score is described herein, as well as what factors contribute to the score, algorithms used to compute the score, and how the score may be leveraged by security administrators to provide differentiated access to corporate data for employees, contractors, and partners.

The continuous zero trust platform 100 allows a variety of client devices 104 as well as identity and access activity data of clients 102 to be ingested and processed to compute trust scores. On client device 104, such as desktop and mobile devices, some of the data collected includes information on the patch level of the operating system, screen lock settings, the use of disk encryption, firewalls, etc. Identity and access activity data of the clients 102 may include, for example, whether and how a user was authenticated, what groups the user belongs to such as via Identity Provider (IDP) assertions, what Application Programming Interfaces (APIs) were being accessed, and whether those access attempts were granted or denied.

A variety of machine learning and statistical techniques, e.g., clustering, change-point detection, regression, and classification and Bayesian inference, may be leveraged to synthesize sophisticated factors related to users, devices, and their access activities that are then combined to compute user and device trust scores.

The machine-learning model may receive a diverse set of features related to users, devices, and access activities. This includes current features such as device health, user behavior, and network activity, which capture real-time information about the system's state. Historical features like previous scores, login attempts, and system updates provide context about past events that may influence current behavior. Additionally, the model receives labels indicating whether observed behavior was good (e.g., legitimate login) or bad (e.g., attempted breach). These labels enable the model to learn from past experiences and adjust its predictions accordingly.

As the machine-learning model may process a rich dataset and generate new, composite features that capture complex relationships between various factors. For example, it might create a feature representing the likelihood of a user being a legitimate administrator based on their past login history and device usage patterns. Similarly, it could generate a feature indicating the potential for a device to be compromised by an attacker due to outdated software or suspicious network activity. The model may also identify patterns in access activity that are indicative of insider threats, such as a user accessing sensitive data during non-work hours. By learning these nuanced relationships through machine learning, the model produces a rich set of features that can be used to inform access control decisions in real-time.

As the model continues to learn and adapt, it begins to generate more sophisticated features that capture the dynamics of user behavior over time. For instance, it might create a feature representing the rate at which a user's access patterns are changing, or the likelihood that a device is being used by an attacker who is attempting to mimic legitimate activity. These features enable the model to make increasingly accurate predictions about access risk and inform more effective access control decisions. The machine-learning model is designed to operate in real-time, processing new data as it becomes available and updating its predictions accordingly. This enables organizations to stay ahead of evolving threats and ensure that only trusted users and devices have access to sensitive resources. As the model continues to learn and adapt, it provides a powerful tool for improving access control decision-making and reducing the risk of security breaches.

In some cases, using trust levels may integrate trust scores into policies and provide a quick mechanism for employees to check their security access posture. Trust levels may be discrete levels created based on the trust score that enables bucketizing of the scores into high, medium, and low trust levels. For example, the security administrators can mandate a high trust level to allow access to sensitive applications and/or restrict access to a subset of data within the application. The employees can quickly check and improve their security access posture from a lower trust level to higher one by potentially fixing issues (e.g., patching their device).

For example, as an example policy framework, to control access to sensitive corporate data, an administrator may performs three simple tasks:

1. Create roles that get auto-bound to users and devices based on their attributes—e.g., user belonging to Contractor group and running High Sierra on MacBook.

2. Specify policies that indicate which roles have access to which corporate resources and under what “conditions”—e.g., Rolel has access to all APIs exposed by an application except the “/admin” API for 72 hrs.

3. Attaches policies to applications that the administrator wants to protect.

FIG. 1 shows one or more operations to access an application resource in a continuous zero-trust platform. When a client 102 (e.g., client device) initiates an access to a corporate resource (e.g., application 116 exposed through an application API), an access proxy (part of a Distributed access proxy 114) checks to see if there is a policy attached to the application 116. The policies may be configured using a cloud command center 106 and distributed to all the access proxies fronting the application 116. If a policy is attached, the cloud command center 106 may check if the role assumed by the client 102 allows access to the requested API under the specified conditions. If these rules are satisfied, an access proxy approves the request and grants access to the requested application resource. Otherwise, access is denied and an unauthorized event alert is generated.

The cloud command center 106 may include a trust provider 108, a policy engine 110, and a trust scoring engine 112. The trust provider 108 may provide access to trust scores and levels calculated by the continuous zero-trust platform. It ensures that the most up-to-date trust information is available for policy decision-making, allowing administrators to make informed decisions about access control. The trust provider 108 may also be used to configure default trust levels or specify custom rules for determining trust levels.

The policy engine 110 may be a rule-based system that determines whether an authenticated client should have access to a requested resource based on the policies defined by the security administrator. It evaluates conditions such as role assignments, device attributes, and access history to make decisions about access control. The policy engine 110 may also be used to enforce multiple policies simultaneously and update policies in real-time.

The trust scoring engine 112 may calculate trust scores for clients based on their behavior and device attributes. The trust scoring engine 112 may use sophisticated machine learning algorithms to analyze access history, device health, user behavior, and network activity to generate a comprehensive trust score. The trust scoring engine 112 may also be used to update trust scores in real-time as new data becomes available, allowing the continuous zero-trust platform to adapt to changing conditions.

Trust scores and/or trust levels are incorporated into the flow by making it one of the conditions in the policy language that needs to be met before granting access. In other words, when an authenticated client 102 requests access, in addition to the other policy checks, the access proxy ensures that a predetermined trust level as specified in the policy condition is met, before granting access. If a trust level is not specified, it is set to a default value so that a role has full access to the resource.

This approach to incorporating trust score also enables the role-proliferation problem to be directly addressed. Since the trust scores are determined on the fly in real-time, the same role can have different levels of access depending on the various factors. The security administrator may indicate a predetermined trust level to access a resource. The continuous zero trust platform 100 also using sophisticated machine learning techniques automatically determines the trust level and provides differentiated access.

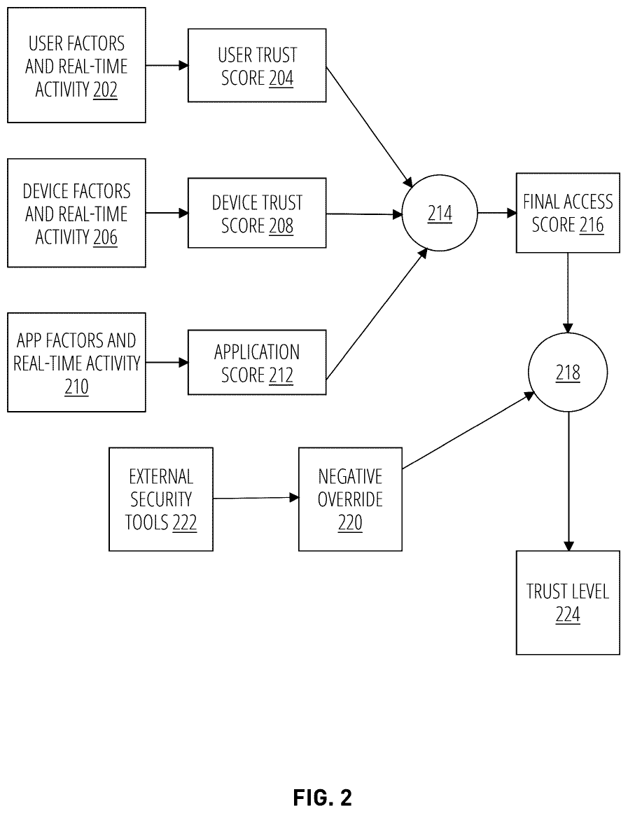

FIG. 2 shows an example trust score computation logic.

In order to determine the trust level at the time of access, the continuous zero trust platform 100 may continuously computes four types of user trust scores 204 capturing trustworthiness of the user based on factors derived from user security settings and real-time activity; device trust score 208 capturing trustworthiness of the device based on factors derived from the security posture of the device and the real-time activity from that device, application scores 212 that is based on application and infrastructure vulnerabilities, and a final access score 216 that may be computed using user, device and application scores to determine if access should be granted at a point of enforcement (PoE).

The final access score 216 may then be converted to the appropriate trust level to allow or deny access. In addition, the platform provides a way to override the final access score 216 based on external security tools 222, such as by a negative override 220, to directly influence the final decision. For example, the final access score 216 may be overrode at a conversion 218 resulting in a final trust level 224.

For example, if an endpoint detection and response (EDR) tool determines that the client 102 used for the access is compromised, it sends an override to the continuous zero trust platform 100 and limits the maximum trust level to low, to disallow any access to sensitive corporate data. This approach provides a seamless mechanism to integrate with several dozen security tools deployed in enterprises today. Trust scores for users and devices are produced by a computation over factors that capture their trustworthiness.

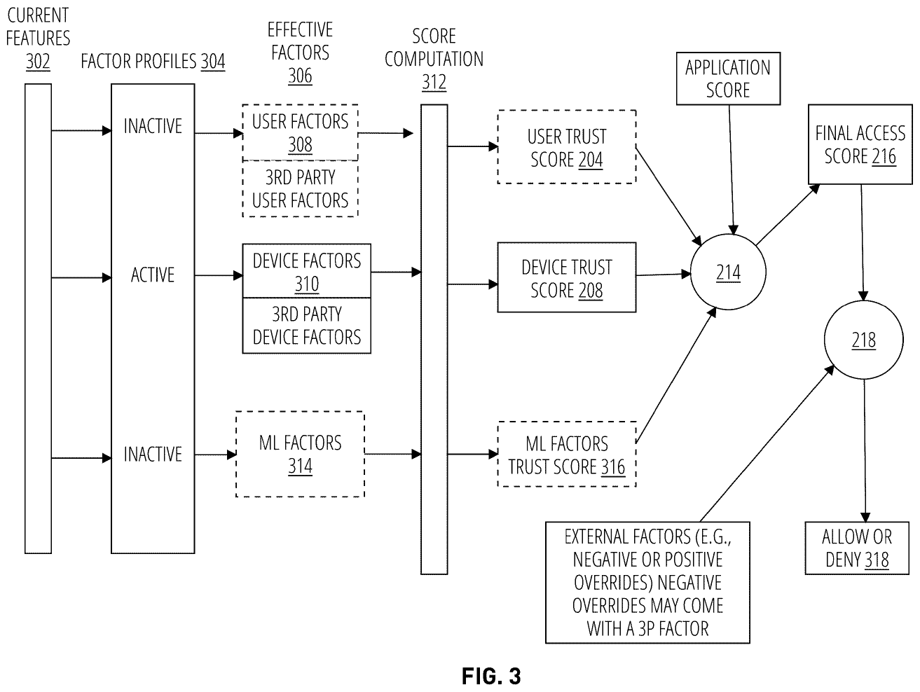

FIG. 3 shows an example trust score, access score, and trust level calculation. More specifically, FIG. 3 shows the steps, data, and components involved in the computations and the determination of a final allow or deny decision. At a high level, raw feature data are collected and converted into factors for scoring algorithms and made available to determine access scores. Access scores and external factors, which may override, are combined to produce the final allow/deny decision.

Internal factors may be grouped into two categories, affirmable and coincidental. Affirmable factors are those a user can take active steps to impact and/or improve their user trust score 204 or device trust score 208. Coincidental factors are things that happen to be true when an access request is submitted. For example, using a device with an “up-to-date OS” would be considered an affirmable factor given that a user may be able to upgrade/update their device operating system (e.g., by filing a support ticket, requesting a new device etc.) whereas it may be coincidental that the user submitted an access request at 11:04 am PST.

Every calculation of the user trust score 204 and the device trust score 208 may include an explanation and recommendations of what can be done to improve the trust score, such as in terms of affirmable factors. End users may be unaware of the split between affirmable and coincidental factors, however, admins or other providers of external factors may be aware to leverage an explanation and recommendation subsystem to support these integrations.

Security administrators may be allowed to turn off certain factors or set different default values for factors specific to their organization. This can be accomplished using factor profiles 304 For example, an organization may decide that it considers macOS to be out of date if it is older than 10.13 which was released in September 2017 rather than 10.14 that is the latest released version today. Factor profiles 304 provides a way to override a default setting.

Current features 302 may include raw data collected about users, devices, resources accessed, behavior etc. The current features 302 may be sourced via different mechanisms, e.g., via an application or other 3rd-party (3P) sources, e.g., via a master data management (MDM). Multiple features may be used to derive a single factor. This allows machine learning to be used over multiple features over time to produce a sophisticated (factor) input into a trust scoring algorithm 214.

Factors may be inputs into the trust scoring algorithm 214. Sets of factors may be versioned to allow the trust scoring algorithms 214 to evolve (v1.0 vs. v2.0). Factors are derived from data (features) of devices, users, their activities and access patterns.

Factor profiles 304 may be used to tailor factors used in the trust score calculations to a specific customer or deployment. Effective factors 306 may be a subset of factors used/enabled to compute a trust score based on the factor profiles 304. As shown in FIG. 3, inactive factor profiles turns off the effective factors, represented by the broken lines, while active factor profiles turn on the effective factors, represented by the solid lines.

Factor values may be customer- or deployment-specific parameters used to tailor a factor to a specific customer or deployment. For example, v1.0 of the device trust scoring algorithm may incorporate the factor “up-to-date OS”, however, every customer may have different criteria for what operating systems are considered up-to-date. This level of configurability allows a trust scoring algorithm that uses the same factor across customers to be used while tailoring it such that every customer has their own relevant baseline.

Trust score algorithm may convert factors and factor values into a numerical value that is used to influence whether access is denied or granted to the given resource (app, API etc.). trust scores plus any overrides are considered together and converted into trust levels (always deny, low, medium, high, always allow). Trust levels of always deny or always allow may be possible via an override.

User factors 308 may be derived from user features (e.g. the user feature may be their email, while the user factor could be based on whether the user was authenticated using multi-factor authentication). Device factors 310 may be derived from device features. Application factors may be derived from application and infrastructure vulnerabilities. Third-party (3P) Factors may be derived from outside systems or via integration with third-party systems.

ML factors 314 may be derived from a mix of current and historical features associated with the active factors, e.g., a history of requests granted or denied, pairings of users and various devices, geo-location data etc. ML factors 314 may be related to users, devices, activities.

External factors may be negative or positive overrides (e.g., if a trusted cybersecurity technology company indicates that a device is compromised, the trust level may be limited to low regardless of any calculated trust score). Overrides are described in a semi-structured way to allow for accessible recommendations to be provided to a user should their trust level be affected by an override.

Table 1 includes sample device factors.

TABLE 1

| Factor name | Motivation |
|---|---|
| Up-to-date OS | More recent OSes have more up-to-date security |
| | fixes |
| Auto-update enabled | Considered a best practice by some customers |
| Firewall enabled | Considered a best practice by some customers |
| ScreenLock enabled | Considered a best practice by some customers |
| Disk Encryption | Considered a best practice by some customers |
| enabled | |
| Org-Preferred | Enterprises may require or prefer that users |
| Apps Running | run specific applications (e.g., an AV) |
| Not-Jail-Broken | Applicable for Mobile platforms |

Table 2 includes sample external (device) factors.

TABLE 2

| Factor name | Motivation |
|---|---|
| Device MDM | Allow an override via an integration with Airwatch |
| Compliant | etc. to indicate whether the device is considered |
| | compliant based on the MDM configuration. |
| | Non-compliant devices may be restricted to a |
| | trust level of Low via an Override |

Table 3 includes sample user factors. User factors 308 may be derived from the properties and activities of the user. Example simple factors are based on whether the user authenticated using Multi-Factor or Single-Factor Authentication, the number of authenticated and unauthenticated requests, user-device pairings/correlations, time since last authentication etc.

TABLE 3

| Factor name | Motivation |
|---|---|
| Type of Authentication | Multi-Factor Authentication is considered |
| Provided | preferable to Single Factor Authentication |
| User-Device | Prior activity involving this user and |
| correlation | device may be used to identify new pairings |
| | or detect anomalous pairings |
| Increased | Changes in rates of unauthorized accesses |
| Unauthenticated | could identify misconfigurations or |
| Request Activity | unexpected activity |

Table 4 includes sample application factors. Application factors may be derived from the configuration, deployment and vulnerability properties of the application. Example simple factors include whether the application is using an up-to-date version of TLS, whether there have been any high severity CVEs have been reported for the application (if applicable) etc.

TABLE 4

| Factor name | Motivation |
|---|---|
| Encrypted | Does the application support or require https |
| Channels | or similar encrypted communications with clients |
| Application | Is the application open to the public, and/or |
| exposure | in a VPC with limited network ACLs? |
| High severity | Does the application have vulnerabilities that |
| CVEs | could cause sensitive data leakage? |

Real-world example scenarios to compute the device trust scores are provided below. Similar algorithms are used to compute the user trust score 204 and application scores 212 using various user and application factors described in the previous sections.

Calculating the device trust score 208 may include getting latest device features, converting latest device features into latest device factors, using an organization's factor profile to determine active device factors to consider, compute trust score based on active device factors, producing factor recommendations, checking for override, determining trust level based on trust score and overrides, and returning trust score, trust level, factor explanation/recommendations

Table 5 shows the applicability of seven device factors on three device platforms (e.g., MacOS 10.14.2, Ubuntu Linux 16.04 LTS, Android 8.0.0).

TABLE 5

| | | | | | | Org- | |
|---|---|---|---|---|---|---|---|
| | | Auto- | | Screen- | Disk | Preferred | Not |
| | Up-to-date | update | Firewall | Lock | Encryption | Apps | Jail- |
| Platform | OS | enabled | enabled | enabled | enabled | Running | Broken |
| Mac OS | Y | Y | Y | N/A | Y | Y | N/A |
| 10.14.2 | | | | | | | |
| Ubuntu | Y | Y | Y | Y | Y | Y | N/A |
| 16.04 LTS | | | | | | | |
| Android | Y | Y | N/A | Y | Y | Y | Y |
| 8.0.0 | | | | | | | |

Recent versions of Mac OS removed the ability to programmatically determine whether the screen lock is enabled therefore the screen-lock enabled factor is not applicable across all Mac OS devices. The not-jail-broken factor is applicable to mobile device platforms, as a result it is not applicable to Mac OS and Ubuntu devices. Mobile devices typically do not have a firewall, as a result the Firewall Enabled Factor is applicable to non-mobile device platforms.

An example trust score calculated for a MacOS device without auto-updates and without org-preferred apps running may be 60, corresponding to a low trust level. Table 6 shows the device factors and the impact of the device factors.

TABLE 6

| | | | | | | Org- | |
|---|---|---|---|---|---|---|---|
| | | Auto- | | Screen- | Disk | Preferred | |
| | Up-to-date | update | Firewall | Lock | Encryption | Apps | NotJail- |
| | OS | enabled | enabled | enabled | enabled | Running | Broken |
| Device | Mac OS | “false” | “true” | N/A | “true” | “false” | N/A |
| Factors | 10.14.2 | | | | | | |
| Device | Full | No | Full | N/A | Full | No | N/A |
| Factor | impact | impact | impact | | impact | impact | |
| impact | because | because | because | | because | because | |
| | 10.14 is | auto- | firewall | | disk | none of | |
| | in the | updates | is | | encryption | the org- | |
| | Org's list | are | turned | | is turned | preferred | |
| | of up-to- | not | on | | on | apps are | |
| | date | enabled | | | | running | |
| | OSes | | | | | | |

An example trust score calculated for a MacOS device with auto-updates and Org-preferred Apps running may be 83, corresponding to a high trust level. Table 7 shows the Device Factors and the impact of the Device Factors.

TABLE 7

| | | | | | | Org- | |
|---|---|---|---|---|---|---|---|
| | | Auto- | | Screen- | Disk | Preferred | Not |
| | Up-to-date | update | Firewall | Lock | Encryption | Apps | Jail- |
| | OS | enabled | enabled | enabled | enabled | Running | Broken |
| Device | MacOS | “true” | “true” | N/A | “true” | “true” | N/A |
| Factors | 10.14.2 | | | | | | |
| Device | Full | Full | Full | N/A | Full | Full | N/A |
| Factor | impact | impact | impact | | impact | impact | |
| impact | because | becaus | because | | because | because | |
| | 10.14 is | e auto- | firewall | | disk | all of the | |
| | in the | updates | is | | encryption | Org- | |
| | org's up- | are | turned | | is turned | preferred | |
| | to-date | enabled | on | | on | apps are | |
| | OSes | | | | | running | |

An example trust score calculated for an Ubuntu device without Org-preferred Apps running may be 83, corresponding to a high trust level.

Table 8 shows the device factors and the impact of the device factors.

TABLE 8

| | | | | | | Org- | |
|---|---|---|---|---|---|---|---|
| | | Auto- | | Screen- | Disk | Preferred | Not |
| | Up-to-date | update | Firewall | Lock | Encryption | Apps | Jail- |
| | OS | enabled | enabled | enabled | enabled | Running | Broken |
| Device | Ubuntu | “true” | “true” | “true” | “true” | “false” | N/A |
| Factors | 16.04 | | | | | | |
| Device | Full | Full | Full | Full | Full | No | N/A |
| Factor | impact | impact | impact | impact | impact | impact | |
| impact | because | because | because | because | because | because | |
| | 16.04 is | | firewall | screen- | disk | none of | |
| | in the | auto- | is | lock is | encryption | the Org- | |
| | Org's list | updates | turned | turned | is turned | preferred | |
| | of up-to- | are | on | on | on | apps are | |
| | date OSes | enabled | | | | running | |

With the ever-changing landscape of corporate workforce and applications, traditional perimeter-based approaches to securing corporate data just cannot keep up. Challenges related to access breaches, role proliferation, and siloed security tooling are hindrances to effectively securing sensitive data. trust score addresses these problems by automatically quantifying trustworthiness of clients based on hundreds of factors, including those from external security tools, to make policy decisions in real-time to allow/deny access. Some examples use an expanded set of factors with more integrations with other security tools (e.g., vulnerability management, IPS/IDS, etc.) and/or use more sophisticated algorithms to address any false positives. Learnings may be leveraged across enterprises to benefit from a network effect to address zero day vulnerabilities.

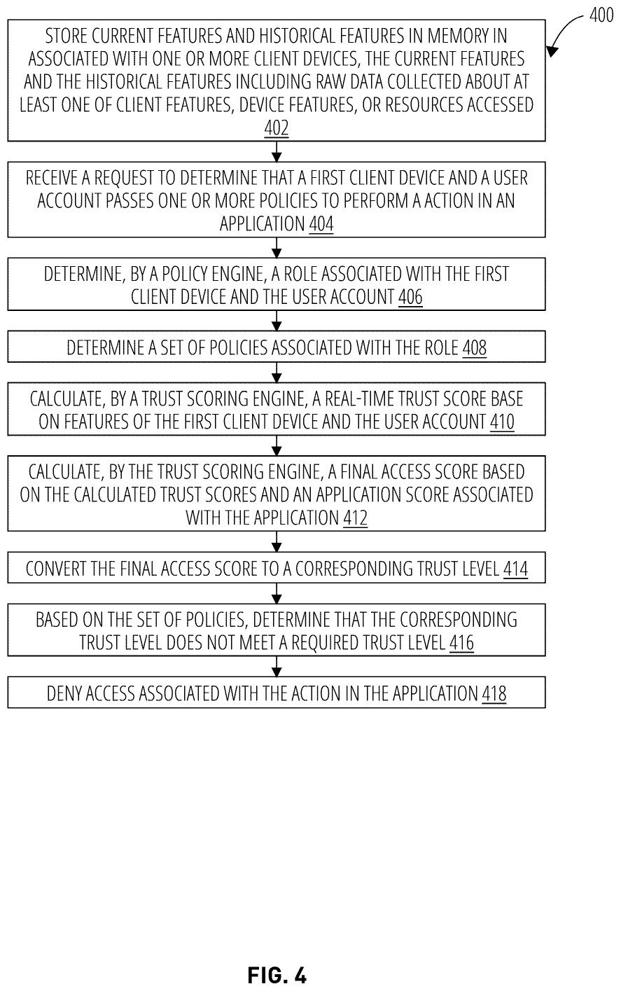

FIG. 4 illustrates an example method 400 for assessing security risk. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method includes storing current features and historical features in memory in associated with one or more client devices at step 402. In some cases, the current features and the historical features includes raw data collected about at least one of client features, device features, or resources accessed. In some cases, the continuous zero trust platform 100 stores the current features and the historical features in databases in the memory. In some cases, the stored current features and the stored historical features include at least one of device health, user behavior, network activity, previous scores, login attempts, or system updates that provide context about past events.

According to some examples, the method includes receiving a request to determine that a first client device and a user account passes one or more policies to perform an action in an application at step 404. In some cases, the request may be based on an initiation of access to a resource exposed through an application programming interface (API). In some cases, an access proxy may determine whether there is an application policy attached to the application.

According to some examples, the method includes determining a role associated with the first client device and the user account at step 406. In some cases, the policy engine 110 or the continuous zero trust platform 100 may determine the role. According to some examples, the method includes determining a set of policies associated with the role at step 408. In some cases the policy engine 110 or the continuous zero trust platform 100 may determine the set of policies.

According to some examples, the method includes calculating a real-time trust score based on features of the first client device and the user account at step 410. In some cases, factors may be derived from the stored current features and the stored historical features. For example, user factors may be derived from the user features, device factors may be derived from the device features, and machine-learning factors may be derived from a mix of the current and the historical features. In some cases, the trust scoring engine 112 or the continuous zero trust platform 100 may calculate the real-time trust score.

In some cases, a selection of active or inactive for factors associated with a first client device of the one or more client devices may be received. In some cases, the calculated real-time trust scores may be based on the active factors. In some cases, the factors from the stored current features and the stored historical features wherein user factors are derived from the user features, device factors are derived from the devise features, and machine-learning factors are from a mix of the current and the historical features.

In some cases, the machine-learning factors may be generated based on a trained machine-learning model. Inputs may include the stored current features and the stored historical features. The generated machine-learning factors may include at least one or more clusters representing devices and users with similar trust levels, one or more alert flags indicating potential trustworthiness issues, one or more predicted trust scores, or one or more predicted labels indicating trustworthiness of a device or user. In some cases, the machine-learning model may be optimized to minimize a loss function, wherein the loss function penalizes incorrect predictions. In some cases, the machine-learning model may be trained based on the generated machine-learning factors to further optimize to minimize the loss function that penalizes the incorrect predictions.

According to some examples, the method includes calculating a final access score based on the calculated trust scores and an application score associated with the application at step 412. In some cases, the trust scoring engine 112 or continuous zero trust platform 100 may calculate the final access score. According to some examples, the method includes converting the final access score to a corresponding trust level at step 414. In some cases, the trust scoring engine 112, trust scoring engine 112, or the continuous zero trust platform 100 may convert the final access score to a corresponding trust level.

According to some examples, the method includes basing on the set of policies, determine that the corresponding trust level does not meet a required trust level at step 416. In some cases, external factors that overrides the required trust level resulting in a higher required trust level may be received. As such, the determining that the corresponding trust level does not meet the required trust level may include not meeting the higher trust level.

According to some examples, the method includes denying access associated with the action in the application at step 418. In some cases, the application score associated with the application, wherein the access proxy denies the access. In some cases, the real-time trust score may be exposed to one or more users. In some cases, an interface with interactive elements that facilitate execution of actionable steps to improve the real-time trust score may be provided.

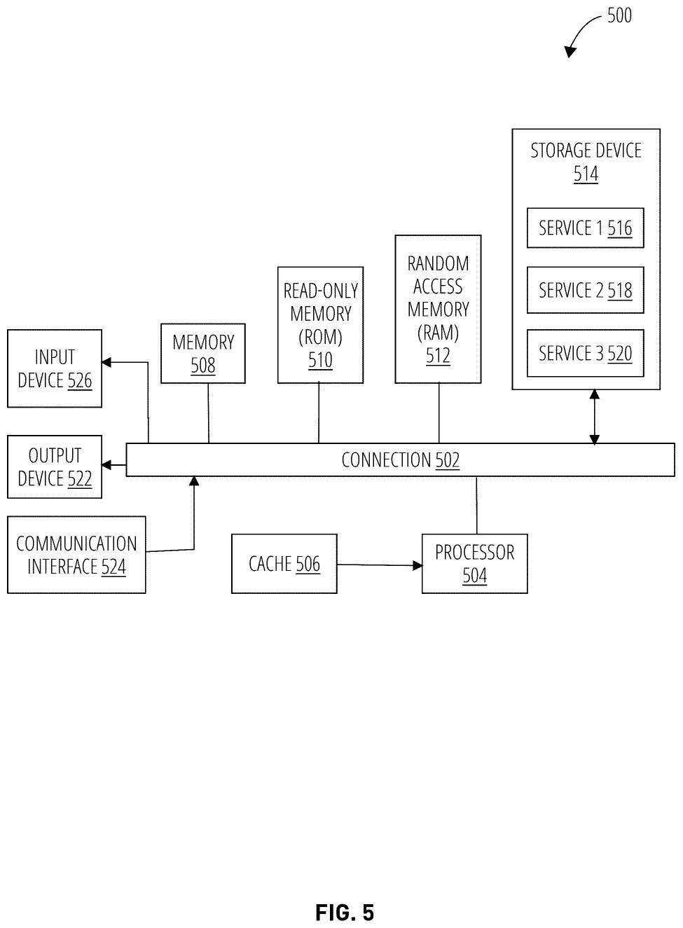

FIG. 5 illustrates a block diagram of an exemplary computing system. The example of computer system 500 can be for example any computing device making up the continuous zero trust platform 100, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computer system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 508 connected directly with, in close proximity to, or integrated as part of processor 504.

Processor 504 can include any general purpose processor and a hardware service or software service, such as services 516, 518, and 520 stored in storage devices 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computer system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computer system 500. Computer system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the hardware components, such as processor 504, connection 502, output device 522, etc., to carry out the function.

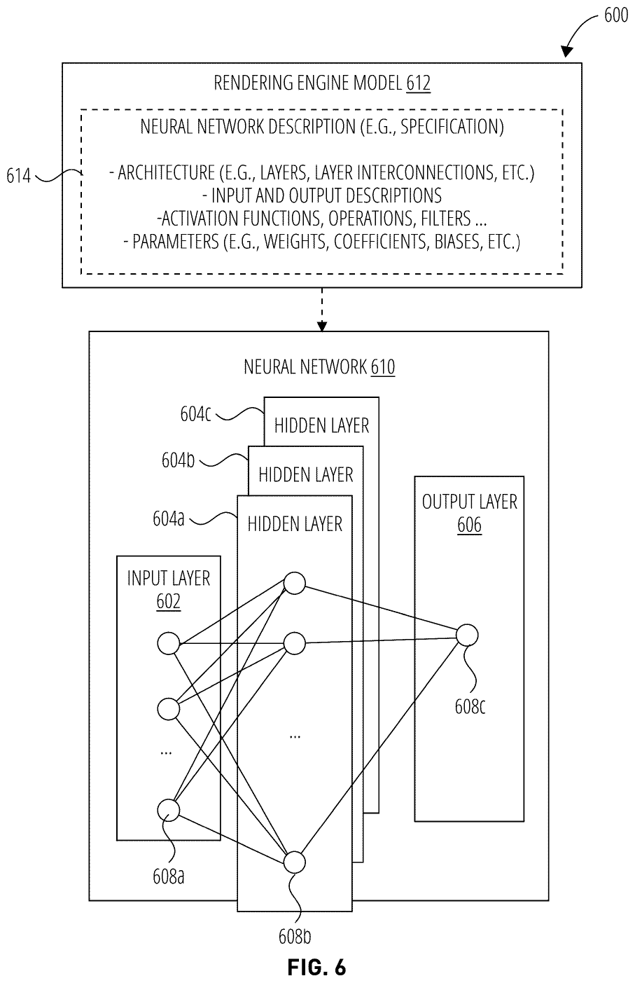

FIG. 6 illustrates an example neural network architecture.

Architecture 600 includes a neural network 610 defined by an example neural network description 614 in node 608c (neural controller). The neural network 610 can represent a neural network implementation of a rendering engine for rendering media data. The neural network description 614 can include a full specification of the neural network 610, including the neural network architecture 600. For example, the neural network description 614 can include a description or specification of the architecture 600 of the neural network 610 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 610 reflects the architecture 600 defined in the input layer 602. In this example, the neural network 610 includes an input layer 602, which includes input data, such as stored current features and stored historical features including at least one of device health, user behavior, network activity, previous scores, login attempts, or system updates that provide context about past events. In one illustrative example, the input layer 602 can include data representing a portion of the input media data such as a patch of data or pixels (e.g., a 728×728 patch of data) in an image corresponding to the input media data (e.g., that of user 702 and/or selected product(s) 708). The neural network 610 includes hidden layers 604a through 604 N (collectively “604” hereinafter). The hidden layers 604 can include n number of hidden layers, where n is an integer greater than or equal to one. The number of hidden layers can include as many layers as needed for a desired processing outcome and/or rendering intent.

The neural network 610 further includes an output layer 606 that provides an output (e.g., rendering output) resulting from the processing performed by the hidden layers 604. In one illustrative example, the output layer 606 can provide machine-learning factors including one or more clusters representing devices and users with similar trust levels, one or more alert flags indicating potential trustworthiness issues, one or more predicted trust scores, or one or more predicted labels indicating trustworthiness of a device or user. The neural network 610 in this example is a multi-layer neural network of interconnected nodes. Each node can represent a piece of information. Information associated with the nodes is shared among the different layers and each layer retains information as information is processed. In some cases, the neural network 610 can include a feed-forward neural network, in which case there are no feedback connections where outputs of the neural network are fed back into itself. In other cases, the neural network 610 can include a recurrent neural network, which can have loops that allow information to be carried across nodes while reading in input. Information can be exchanged between nodes through node-to-node interconnections between the various layers.

Nodes of the input layer 602 can activate a set of nodes in the first hidden layer 604a. For example, as shown, each of the input nodes of the input layer 602 is connected to each of the nodes of the first hidden layer 604a. The nodes of the hidden layers hidden layer 604a can transform the information of each input node by applying activation functions to the information. The information derived from the transformation can then be passed to and can activate the nodes of the next hidden layer (e.g., 604b), which can perform their own designated functions. Example functions include convolutional, up-sampling, data transformation, pooling, and/or any other suitable functions. The output of the hidden layer (e.g., 604b) can then activate nodes of the next hidden layer (e.g., 604N), and so on. The output of the last hidden layer can activate one or more nodes of the output layer 606, at which point an output is provided. In some cases, while nodes (e.g., nodes 608a, 608b, 608c) in the neural network 610 are shown as having multiple output lines, a node has a single output and all lines shown as being output from a node represent the same output value. In some cases, each node or interconnection between nodes can have a weight that is a set of parameters derived from training the neural network 610.

For example, an interconnection between nodes can represent a piece of information learned about the interconnected nodes. The interconnection can have a numeric weight that can be tuned (e.g., based on a training dataset), allowing the neural network 610 to be adaptive to inputs and able to learn as more data is processed. The neural network 610 can be pre-trained to process the features from the data in the input layer 602 using the different hidden layers 604 in order to provide the output through the output layer 606. In an example in which the neural network 610 is used to identify the machine-learning factors, the neural network 610 can be trained using training data that includes generated machine-learning factors, the stored current features, and the stored historical features including at least one of device health, user behavior, network activity, previous scores, login attempts, or system updates that provide context about past events. For instance, training images can be input into the neural network 610, which can be processed by the neural network 610 to generate outputs which can be used to tune one or more aspects of the neural network 610, such as weights, biases, etc. In some cases, the neural network 610 can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 610, the output can include values that do not give preference to any particular class due to the weights being randomly selected at initialization. With the initial weights, the neural network 610 is unable to determine low level features and thus cannot make an accurate determination of what the classification of the object might be. A loss function can be used to analyze errors in the output. Any suitable loss function definition can be used. The loss (or error) can be high for the first training dataset (e.g., images) since the actual values will be different than the predicted output.

The goal of training is to minimize the amount of loss so that the predicted output comports with a target or ideal output. The neural network 610 can perform a backward pass by determining which inputs (weights) most contributed to the loss of the neural network 610, and can adjust the weights so that the loss decreases and is eventually minimized. A derivative of the loss with respect to the weights can be computed to determine the weights that contributed most to the loss of the neural network 610. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 610 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 610 can represent any other neural or deep learning network, such as an autoencoder, a deep belief nets (DBNs), a recurrent neural networks (RNNs), etc.

1. A computer-implemented method for assessing action risks, the method comprising:
storing data in memory regarding current features and historical features associated with one or more devices;
receiving a request sent over a communication network, wherein the request concerns performance of a requested action within a device application;
identifying a role associated with the request based on at least one of a device or user account associated with the request, wherein the role is identified by a policy engine;
determining one of a plurality of sets of policies associated with the identified role;
assigning a trust score in real-time based on the current features and the historical features associated with the device or the user account, wherein the real-time trust score is assigned by a trust scoring engine;
identifying a required trust level in accordance with the determined set of policies;
determining that one or more external factors not associated with the device override the identified trust level so as to require a higher trust level that is not met; and
denying access to the requested action within the device application.

2. The computer-implemented method of claim 1, further comprising:
initially identifying an initial required trust level; and
receiving information regarding the one or more external factors associated with the initial required trust level.

3. The computer-implemented method of claim 1, further comprising deriving one or more factors from the current features and the historical features wherein one or more of user factors are derived from user features, device factors are derived from the device features, and machine-learning factors are derived from a mix of the current features and the historical features.

4. The computer-implemented method of claim 3, further comprising receiving a selection of active or inactive for at least one of the user factors, the device factors, or the machine-learning factors, wherein assigning the real-time trust score is further based on the active factors.

5. The computer-implemented method of claim 3, further comprising generating the machine-learning factors, based on a trained machine-learning model, wherein inputs include the current features and the historical features, and wherein the generated machine-learning factors include at least one or more clusters representing devices and users with similar trust levels, one or more alert flags indicating potential trustworthiness issues, one or more predicted trust scores, or one or more predicted labels indicating trustworthiness of a device or user, and wherein the machine-learning model is tuned to minimize a loss function that penalizes incorrect predictions.

6. The computer-implemented method of claim 5, further comprising training the machine-learning model based on the generated machine-learning factors to minimize the loss function that penalizes the incorrect predictions.

7. The computer-implemented method of claim 1, wherein the current features and the historical features include at least one of device health, user behavior, network activity, previous scores, login attempts, or system updates that provide context about past events.

8. The computer-implemented method of claim 1, further comprising:
exposing the real-time trust score to one or more users; and
providing an interface with interactive elements that facilitate execution of actionable steps to improve the real-time trust score.

9. The computer-implemented method of claim 1, wherein receiving the request is based on an initiation of access to a resource exposed through an application programming interface (API).

10. The computer-implemented method of claim 9, further comprising determining, by an access proxy, there is an application policy attached to the application, wherein the application score associated with the application, wherein the access proxy denies the access.

11. A computing apparatus for assessing action risks, the computing apparatus comprising:
one or more databases in memory, the databases storing data regarding current features and historical features associated with one or more devices;
a communication interface that communicates over a communication network to receive a request to determine that at least one of a device of the one or more devices and a user account passes one or more policies to perform an action in an application; and
one or more processors that execute instructions stored in the memory, wherein the processors execute the instructions for:
identifying a role associated with the request based on at least one of a device or user account associated with the request, wherein the role is identified by a policy engine;
determining one of a plurality of sets of policies associated with the identified role;
assigning a trust score in real-time based on the current features and the historical features associated with the device or the user account, wherein the real-time trust score is assigned by a trust scoring engine;
identifying a required trust level in accordance with the determined set of policies;
determining that one or more external factors not associated with the device override the identified trust level so as to require a higher trust level that is not met; and
denying access to the requested action within the device application.

12. The computing apparatus of claim 11, wherein the processors execute the instructions for:
initially identifying an initial required trust level; and
receiving information regarding one or more external factors associated with the initial required trust level.

13. The computing apparatus of claim 11, wherein the processors execute the instructions for: deriving one or more factors from the current features and the historical features wherein one or more of user factors are derived from user features, device factors are derived from the device features, and machine-learning factors are derived from a mix of the current features and the historical features.

14. The computing apparatus of claim 13, wherein the processors execute the instructions for receiving a selection of active or inactive for at least one of the user factors, the device factors, or the machine-learning factors, wherein assigning the real-time trust score is further based on the active factors.

15. The computing apparatus of claim 13, wherein the processors execute the instructions for generating the machine-learning factors, based on a trained machine-learning model, wherein inputs include the current features and the historical features, and wherein the generated machine-learning factors include at least one or more clusters representing devices and users with similar trust levels, one or more alert flags indicating potential trustworthiness issues, one or more predicted trust scores, or one or more predicted labels indicating trustworthiness of a device or user, and wherein the machine-learning model is tuned to minimize a loss function that penalizes incorrect predictions.

16. The computing apparatus of claim 15, wherein the current features and the historical features include at least one of device health, user behavior, network activity, previous scores, login attempts, or system updates that provide context about past events, and wherein the processors execute the instructions for training the machine-learning model based on the generated machine-learning factors to minimize the loss function that penalizes the incorrect predictions.

17. The computing apparatus of claim 11, wherein the processors execute the instructions for:
exposing the real-time trust score to one or more users; and
providing an interface with interactive elements that facilitate execution of actionable steps to improve the real-time trust score.

18. The computing apparatus of claim 11, wherein receiving the request is based on an initiation of access to a resource exposed through an application programming interface (API).

19. The computing apparatus of claim 18, wherein the processors execute the instructions for determining, by an access proxy, there is an application policy attached to the application, wherein the application score associated with the application, wherein the access proxy denies the access.

20. A non-transitory computer-readable storage medium having embodied thereon a program executable by a processor for implementing a computer-implemented method for assessing action risks, the method comprising:
storing data in memory regarding current features and historical features associated with one or more devices;
receiving a request sent over a communication network, wherein the request concerns performance of a requested action within a device application;
identifying a role associated with the request based on at least one of a device or user account associated with the request, wherein the role is identified by a policy engine;
determining one of a plurality of sets of policies associated with the identified role;
assigning a trust score in real-time based on the current features and the historical features associated with the device or the user account, wherein the real-time trust score is assigned by a trust scoring engine;
identifying a required trust level in accordance with the determined set of policies;
determining that one or more external factors not associated with the device override the identified trust level so as to require a higher trust level that is not met; and
denying access to the requested action within the device application.
